(19) United States
(12) Patent Application Publication
(10) Pub. No.: US 2015/0236328 A1
(43) Pub. Date: Aug. 20, 2015

(54) SECONDARY BATTERY

(71) Applicants: Hideki Shinohara, Hitachinaka (JP); Yutaka Sato, Hitachinaka (JP)

(72) Inventors: Hideki Shinohara, Hitachinaka (JP); Yutaka Sato, Hitachinaka (JP)

(73) Assignee: Hitachi Automotive Systems, Ltd., Hitachinaka-shi, Ibaraki (JP)

(21) Appl. No.: 14/422,510

(22) PCT Filed: Aug. 28, 2012
(86) PCT No.: PCT/JP2012/071668

§ 371 Date: Feb. 19, 2015

(51) Int. Cl. H01M 2/26; H01M 2/30; H01M 2/34

(52) U.S. Cl. CPC H01M 2/26; H01M 2/348; H01M 2/30; H01M 2200/10; H01M 10/0525

(57) ABSTRACT

A secondary battery: includes a power generation element having an electrode; a battery container which stores the power generation element, an external terminal arranged on the battery container, and a current collector member including an electrode connection part connected to the electrode of the power generation element. A terminal connection part is connected to the external terminal, and a thermal connection part is formed between the electrode connection part and the terminal connection part and a temperature control member is provided for the terminal connection part to restrict the temperature rise of the current collector member. The temperature control member is formed of a composite material made by dispersing a filler having the electric insulation property in a matrix. The matrix has a transformation point in a temperature range lower than the melting point of the current collector member. The filler has higher thermal conductivity than the matrix.

### TECHNICAL FIELD

The present invention relates to a secondary battery.

### BACKGROUND ART

Secondary batteries having high capacity (Wh) are being developed in recent years as the power sources for hybrid electric vehicles, battery electric vehicles, etc. Among such secondary batteries, lithium-ion secondary batteries in prismatic shapes (prismatic lithium-ion secondary batteries) having high energy density (Wh/kg) are attracting great attention (see Patent Document 1).

In such a prismatic lithium-ion secondary battery, a winding electrode in a flat shape is formed by winding a stack of a positive electrode, a negative electrode and a separator (for the electric insulation between the positive and negative electrodes) together around an axis. The winding electrode is electrically connected to external terminals on a battery cover via current collector members. The winding electrode is stored in a battery case and an opening part of the battery case is sealed up by welding the battery cover to the opening part. The secondary battery is formed by injecting an electrolyte into the battery case storing the winding electrode through an injection vent of the battery case, inserting a vent plug into the injection vent, and welding the vent plug to the injection vent by laser welding to seal up the injection vent.

In the secondary battery described in the Patent Document 1, each current collector member is equipped with a fuse. When excessive electric current over a prescribed value flows through a current collector member, the fuse is melted and disconnected and the electrical connection is interrupted, by which the temperature rise of the current collector members is prevented.

### PRIOR ART LITERATURE

### Patent Document

Patent Document 1: JP-2011-210717-A

### SUMMARY OF THE INVENTION

### Problem to be Solved by the Invention

In the secondary battery described in the Patent Document 1, when excessive current flows through a current collector member, the heated fuse is melted and disconnected and the electrical connection between the external terminal and the power generation element (winding electrode) is interrupted. Therefore, in the secondary battery of the Patent Document 1, high electric power can remain in the secondary battery and the high energy state of the secondary battery might be maintained after the disconnection of the fuse.

### Means for Solving the Problem

According town aspect of the present invention, there is provided a secondary battery comprising: a power generation element having an electrode; a battery container which stores the power generation element; an external terminal which is arranged on the battery container; a current collector member including an electrode connection part which is connected to the electrode of the power generation element, a terminal connection part which is connected to the external terminal, and a thermal connection part which is formed between the electrode connection part and the terminal connection part; and a temperature control member which is provided for the terminal connection part to restrict the temperature rise of the current collector member. The temperature control member is formed of a composite material made by dispersing a filler having the electric insulation property in a matrix made of plastic having the electric insulation property. The matrix has a transformation point in a temperature range lower than the melting point of the current collector member provided with the temperature control member. The filler has higher thermal conductivity than the matrix.

### Effect of the Invention

According to the present invention, when excessive current flows through the current collector member, the temperature rise of the current collector member can be restricted without interrupting the electrical connection between the external terminal and the power generation element.

### BRIEF DESCRIPTION OF THE DRAWINGS

FIG. 1 is an overall perspective showing an external view of a secondary battery according to a first embodiment of the present invention.

FIG. 2 is an exploded perspective view showing the configuration of the secondary battery in FIG. 1.

FIG. 3 is a perspective view showing a winding electrode stored in a battery case of the secondary battery in FIG. 1.

FIGS. 4(a) to (d) are schematic diagrams showing a clip-shaped temperature control member attached to each current collector member in the secondary battery according to the first embodiment of the present invention.

FIG. 5 is a conceptual diagram showing a composite material forming the temperature control member.

FIG. 6 is a graph showing the relation between the thermal conductivity of the temperature control member and the maximum temperature of a positive electrode current collector member.

FIG. 7 is a schematic diagram showing a temperature control member attached to each current collector member in a secondary battery according to a second embodiment of the present invention with the use of an adhesive agent.

FIG. 8 is a schematic diagram showing a temperature control member formed integrally with each current collector member in a secondary battery according to a third embodiment of the present invention by means of outsert molding.

### MODE FOR CARRYING OUT THE INVENTION

With reference to the drawings, a description will be given in detail of preferred embodiments of the present invention. In each of the following embodiments, a secondary battery according to the present invention is applied to a prismatic lithium-ion battery.

### First Embodiment

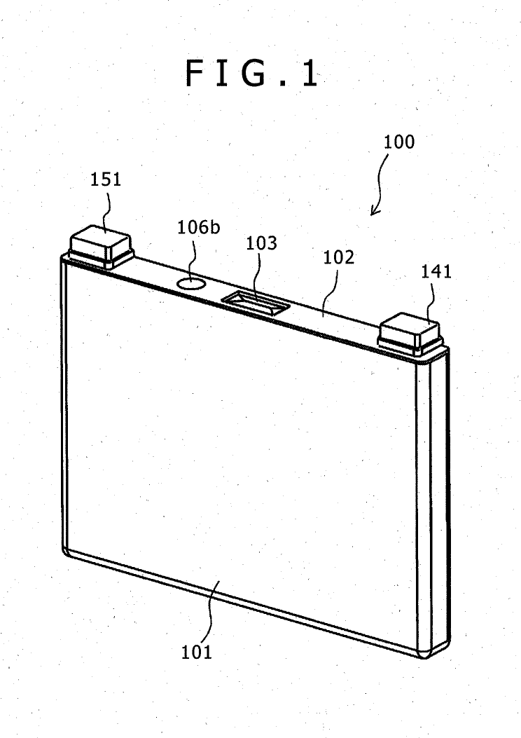

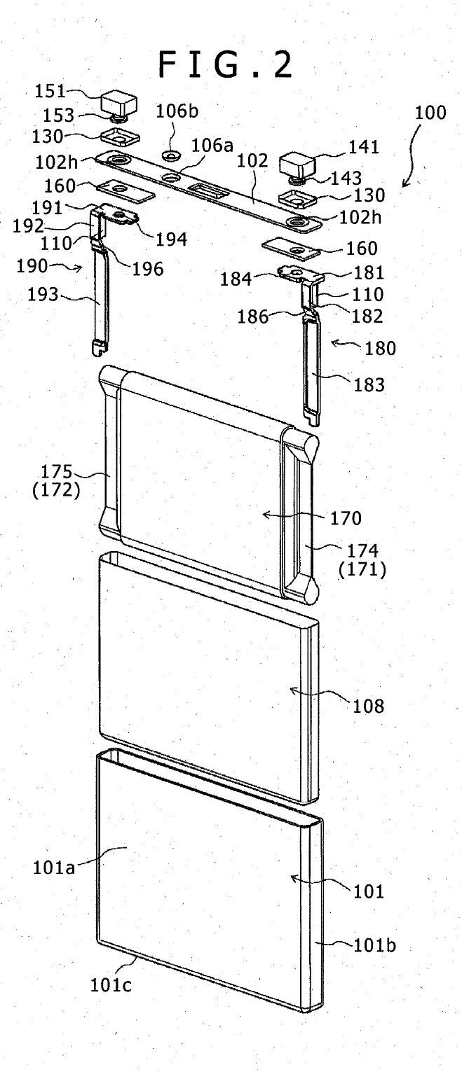

FIG. 1 is an overall perspective showing the external view of a secondary battery 100. FIG. 2 is an exploded perspective view showing the configuration of the secondary battery 100 in FIG. 1.

As shown in FIGS. 1 and 2, the secondary battery 100 of a shape like a flat rectangular prism has a battery container including a battery case 101 and a battery cover 102. The material of the battery case 101 and the battery cover 102 is aluminum, aluminum alloy, or the like.

As shown in FIG. 2, a winding electrode 170 is stored in the battery case 101. The battery case 101, having a pair of wide surfaces 101a, a pair of narrow surfaces 101b and a base surface 101c, is formed in a bottomed box shape with an opening at one end. The winding electrode 170 is covered with an insulating case 108 and the covered winding electrode 170 is stored in the battery case 101. The material of the insulating case 108 is plastic (resin) having the electric insulation property, such as polypropylene or polyethylene terephthalate. With the insulating case 108, the winding electrode 170 is electrically insulated from the bottom and side faces of the battery case 101.

As shown in FIGS. 1 and 2, the battery cover 102 in a shape like a rectangular flat plate is welded to the battery case 101 by means of laser welding so as to stop up the opening of the battery case 101. In other words, the battery cover 102 seals up the opening of the battery case 101. The battery cover 102 is equipped with a positive external terminal 141 and a negative external terminal 151.

The positive external terminal 141 is electrically connected to a positive electrode 174 of the winding electrode 170 via a positive electrode current collector member 180. The negative external terminal 151 is electrically connected to a negative electrode 175 of the winding electrode 170 via a negative electrode current collector member 190. Thus, the winding electrode 170 supplies electric power to an external load via the positive external terminal 141 and the negative external terminal 151, or the winding electrode 170 is charged with electric power generated outside and supplied via the positive external terminal 141 and the negative external terminal 151.

As shown in FIG. 2, an injection vent 106a for injecting an electrolyte into the battery container is formed through the battery cover 102. After the injection of the electrolyte, the injection vent 106a is sealed up with a vent plug 106b. As the electrolyte, a nonaqueous electrolyte made by dissolving lithium salt (e.g., lithium hexafluorophosphate [LiPF₆]) in a carbonate ester-based organic solvent (e.g., ethylene carbonate) can be used, for example.

As shown in FIG. 1, a gas release vent 103 is concavely formed on the surface of the battery cover 102. The gas release vent 103 is formed by thinning down a part of the battery cover 102 by means of press work so that the degree of stress concentration becomes relatively high when high internal pressure acts thereon. The gas release vent 103 cleaves and opens when gas is generated in the battery container by the heating of the secondary battery 100 due to an abnormality (e.g., overcharging) and the pressure in the battery container rises to a prescribed pressure (e.g., approximately 1 MPa). The function of the gas release vent 103 releasing the gas from the inside reduces the pressure in the battery container.

As shown in FIG. 2, the positive external terminal 141, the negative external terminal 151, the positive electrode current collector member 180 and the negative electrode current collector member 190 are attached to the battery cover 102. Each terminal receiving part 130 is arranged between the positive external terminal 141 and the battery cover 102 and between the negative external terminal 151 and the battery cover 102. Each current collector member receiving part 160 is arranged between the positive electrode current collector member 180 and the battery cover 102 and between the negative electrode current collector member 190 and the battery cover 102.

The material of the positive external terminal 141 and the positive electrode current collector member 180 is aluminum-based metal, that is, aluminum or aluminum alloy. The positive external terminal 141 has an external terminal part of a prism shape and a projection part projecting toward the battery cover 102 from a surface of the external terminal part facing the battery cover 102. The projection part is inserted into a through hole of the terminal receiving part 130, a through hole 102h of the battery cover 102, a through hole of the current collector member receiving part 160, and a through hole 184 of a terminal connection part 181 of the positive electrode current collector member 180. The tip end of the projection part is fixed to the terminal connection part 181 of the positive electrode current collector member 180 in the battery container by means of crimping, by which a crimped part 143 is formed. After the crimping fixation, the crimped part 143 and the terminal connection part 181 undergoes laser spot welding, by which the positive external terminal 141 and the positive electrode current collector member 180 are electrically connected together while also being fixed to the battery cover 102.

The material of the negative external terminal 151 and the negative electrode current collector member 190 is copper-based metal, that is, copper or copper alloy. The negative external terminal 151 has an external terminal part of a prism shape and a projection part projecting toward the battery cover 102 from a surface of the external terminal part facing the battery cover 102. The projection part is inserted into a through hole of the terminal receiving part 130, a through hole 102h of the battery cover 102, a through hole of the current collector member receiving part 160, and a through hole 194 of a terminal connection part 191 of the negative electrode current collector member 190. The tip end of the projection part is fixed to the terminal connection part 191 of the negative electrode current collector member 190 in the battery container by means of crimping, by which a crimped part 153 is formed. After the crimping fixation, the crimped part 153 and the terminal connection part 191 undergoes laser spot welding, by which the negative external terminal 151 and the negative electrode current collector member 190 are electrically connected together while also being fixed to the battery cover 102.

The material of the terminal receiving parts 130 and the current collector member receiving parts 160 is plastic having the electric insulation property, such as polybutylene terephthalate, polyphenylene sulphide or perfluoroalkoxy fluorocarbon resin. Each terminal receiving part 130 is arranged between the positive external terminal 141 and the battery cover 102 and between the negative external terminal 151 and the battery cover 102. Therefore, each of the positive external terminal 141 and the negative external terminal 151 is electrically insulated from the battery cover 102. Each current collector member receiving part 160 is arranged between the terminal connection part 181 of the positive electrode current collector member 180 and the battery cover 102 and between the terminal connection part 191 of the negative electrode current collector member 190 and the battery cover 102. Therefore, each of the positive electrode current collector member 180 and the negative electrode current collector member 190 is electrically insulated from the battery cover 102.

As shown in FIG. 2, the positive electrode current collector member 180 includes: the terminal connection part 181 in a shape like a rectangular flat plate arranged along the inner surface of the battery cover 102; a flat plate part 182 bending substantially at the right angle from a long side of the terminal connection part 181 and extending toward the base surface 101c of the battery case 101 along the wide surface 101a of the battery case 101; and a joint plate 183 connected to the flat plate part 182 via a connection part 186 formed at the lower end of the flat plate part 182. The flat plate part 182 has a flat contact surface which a temperature control member 110 to be explained later abuts. The joint plate 183 is joined to the positive electrode 174 of the winding electrode 170 by means of ultrasonic bonding.

Similarly, the negative electrode current collector member 190 includes: the terminal connection part 191 in a shape like a rectangular flat plate arranged along the inner surface of the battery cover 102; a flat plate part 192 bending substantially at the right angle from a long side of the terminal connection part 191 and extending toward the base surface 101c of the battery case 101 along the wide surface 101a of the battery case 101; and a joint plate 193 connected to the flat plate part 192 via a connection part 196 formed at the lower end of the flat plate part 192. The flat plate part 192 has a flat contact surface which a temperature control member 110 to be explained later abuts. The joint plate 193 is joined to the negative electrode 175 of the winding electrode 170 by means of ultrasonic bonding.

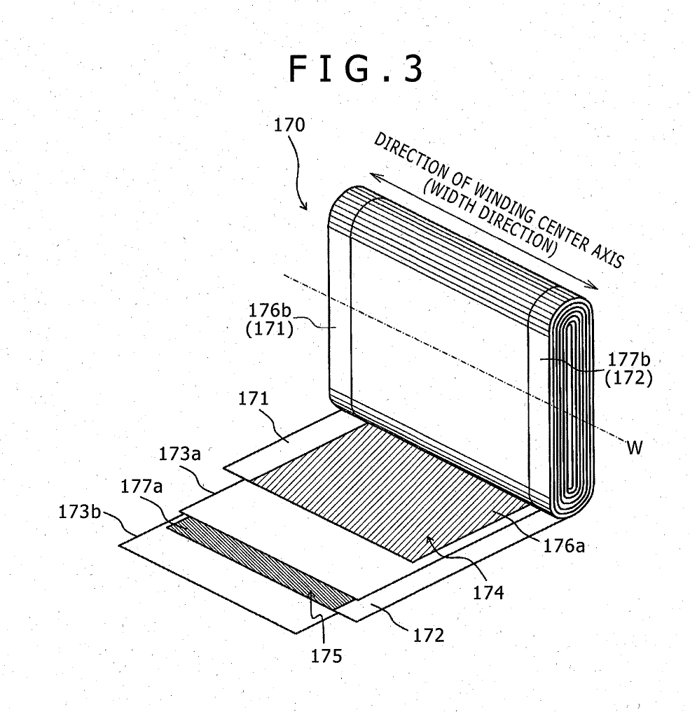

The winding electrode 170 will be explained below with reference to FIG. 3. FIG. 3 is a perspective view showing the winding electrode 170 stored in the battery case 101 of the secondary battery 100. The winding electrode 170 with its winding end opened and extended is shown in FIG. 3. The winding electrode 170 serving as a power generation element is formed as a laminated structure by winding the positive and negative electrodes 174 and 175 in elongated shapes around a central axis W into a flat shape with separators 173a and 173b inserted.

The positive electrode 174 has a positive electrode coated part 176a where both sides of positive electrode foil 171 is coated with a positive electrode active material mix and a positive electrode non-coated part 176b where both sides of the positive electrode foil 171 is not coated with the positive electrode active material mix. The positive electrode active material mix is made by mixing a binder into positive electrode active material. The negative electrode 175 has a negative electrode coated part 177a where both sides of negative electrode foil 172 have been coated with a negative electrode active material mix and a negative electrode non-coated part 177b where both sides of the negative electrode foil 172 have not been coated with the negative electrode active material mix. The negative electrode active material mix is made by a binder being mixed into negative electrode active material. The charging and discharging is done between the positive electrode active material and the negative electrode active material.

The positive electrode foil 171 is aluminum foil or aluminum alloy foil having a thickness of approximately 20 to 30 μm. The negative electrode foil 172 is copper foil or copper alloy foil having a thickness of approximately 15 to 20 μm. The material of the separators 173a and 173b is fine porous polyethylene resin that is permeable to lithium ions. The positive electrode active material is lithium-containing transition metal complex oxide such as lithium manganate. The negative electrode active material is carbon material, such as graphite, that is capable of reversibly occluding and discharging lithium ions.

The winding electrode 170 includes a laminated part of the positive electrode non-coated part 176b (exposed part of the positive electrode foil 171) at one end in its width direction (the direction of the winding center axis W orthogonal to the winding direction) and a laminated part of the negative electrode non-coated part 177b (exposed part of the negative electrode foil 172) at the other end in the width direction. The laminated part of the positive electrode non-coated part 176b and the laminated part of the negative electrode non-coated part 177b are flattened out in advance and electrically connected respectively to the joint plate 183 of the positive electrode current collector member 180 and the joint plate 193 of the negative electrode current collector member 190 by means of ultrasonic bonding.

The winding electrode 170 is stored in the battery container so that one of two curved parts of the winding electrode 170 faces the battery cover 102, the other of the curved parts faces the base surface 101c, and flat parts of the winding electrode 170 face the wide surfaces 101a.

In the secondary battery 100 configured as above, when excessive current flows, a particular part of the current collector members can be heated to a high temperature and partially melted consequently. The area that tends to be heated to a high temperature is a part where the electrical resistance increases due to a decrease in the cross-sectional area or due to undergoing a bending process. The position of such a part varies depending on the shapes of the current collector members.

In the positive electrode current collector member 180 and the negative electrode current collector member 190 in the present embodiment, the flat plate parts 182 and 192 tend to be heated to a high temperature the most. In the present embodiment, each of the flat plate parts 182 and 192 is provided with the temperature control member 110, by which the temperature rise of the positive electrode current collector member 180 and the negative electrode current collector member 190 is restricted.

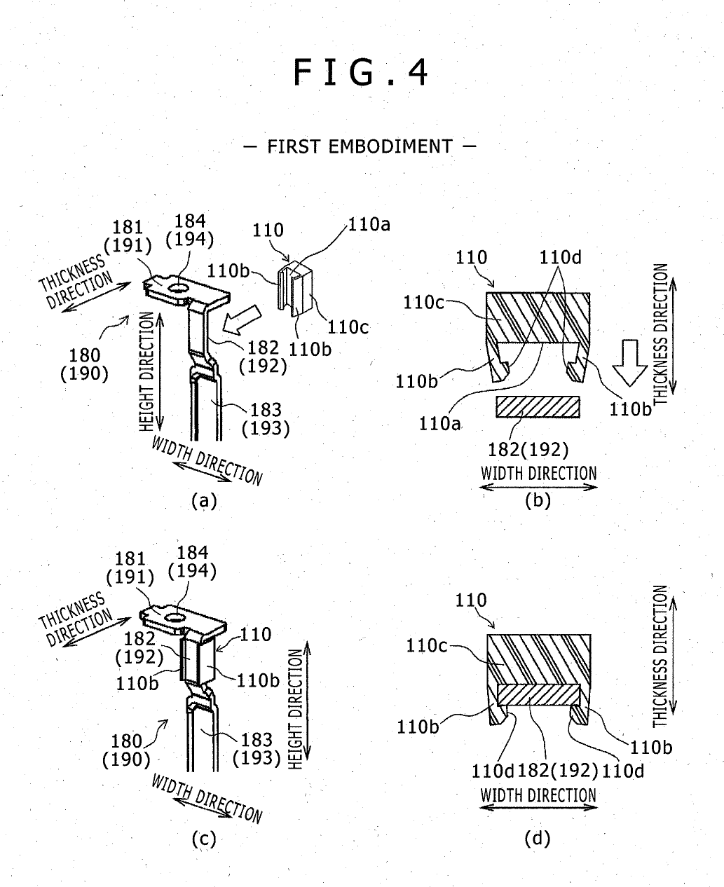

FIGS. 4(a) to (d) are schematic diagrams showing a clip-shaped temperature control member 110 attached to each current collector member in the secondary battery 100 according to the first embodiment of the present invention. While only the temperature control member 110 connected to the positive electrode current collector member 180 is shown in FIG. 4, the negative electrode current collector member 190 is also provided with the same temperature control member 110. Thus, reference numerals of the components of the negative electrode current collector member 190 are shown in FIG. 4 in the parenthesized form for the convenience of illustration. Since the same temperature control members 110 are connected to the positive electrode current collector member 180 and the negative electrode current collector member 190, the temperature control member 110 connected to the positive electrode current collector member 180 will be explained below as the representative example. In the following explanation, the direction of the winding center axis W of the winding electrode 170 stored in the battery case 101 will be referred to as a “width direction”, the direction of a line connecting the battery cover 102 and the base surface 101c (i.e., depth direction of the battery case) will be referred to, as a “height direction”, and the direction orthogonal to the height direction and the width direction will be referred to as a “thickness direction” as indicated in FIG. 4.

As shown in FIG. 4(a) and FIG. 4(b), the temperature control member 110 has a base part 110c in a rectangular prism shape and a pair of engaging pieces 110b. The engaging pieces 110b are formed to protrude from long sides of a surface of the base part 110c facing the positive electrode current collector member 180 toward the current collector member (i.e., in the thickness direction). Each engaging piece 110b, capable of elastically deforming in the width direction, has a latch 110d formed at its tip end to protrude inward. The engaging piece 110b is in a shape like the letter “L” in the plan view. The surface of the base part 110c between the pair of engaging pieces 110b is used as a contact surface 110a to be set in contact with the flat plate part 182 of the positive electrode current collector member 180. The width dimension of the contact surface 110a and that of the flat plate part 182 are set substantially equal to each other. As shown in FIG. 4(b), the engaging pieces 110b in the horizontal sectional view are inclined inward so that the distance between the engaging pieces 110b decreases toward the latches 110d formed at their tip ends.

When external force is applied to the temperature control member 110 to press it toward the flat plate part 182 of the positive electrode current collector member 180, the pair of engaging pieces 110b is slid onto the flat plate part 182 while opening outward. When the temperature control member 110 has been pressed in and the contact surface 110a of the base part 110c is consequently in contact with the contact surface of the flat plate part 182 as shown in FIGS. 4(c) and 4(d), the temperature control member 110 is made to be fixed on the flat plate part 182 due to the elastic resilience of the pair of engaging pieces 110b. Once the flat plate part 182 fits in the space between the pair of engaging pieces 110b, the flat plate part 182 is sandwiched between the engaging pieces 110b. Then, a surface of the flat plate part 182 opposite to the contact surface is pressed by the latches 110d toward the base part 110c, by which the temperature control member 110 is fixed in contact with the flat plate part 182.

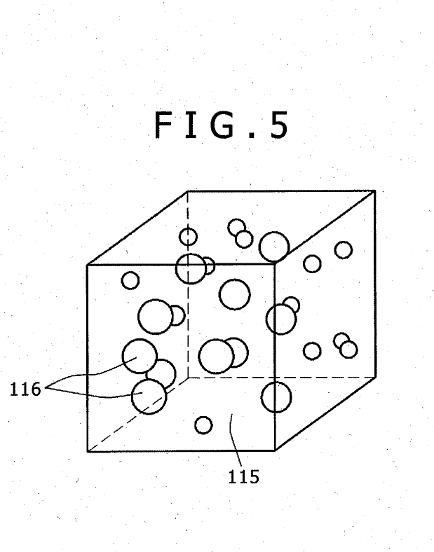

FIG. 5 is a conceptual diagram showing a composite material forming the temperature control member 110. The temperature control member 110 is formed of a composite material made by dispersing a filler 116 having the electric insulation property in a matrix 115 made of plastic having the electric insulation property.

A material having a transformation point in a temperature range lower than the melting point of the material of the positive electrode current collector member 180 (i.e., aluminum-based metal) to which the temperature control member 110 is attached is selected as the matrix 115. The melting point of the aluminum-based metal forming the positive electrode current collector member 180 used in the present embodiment is approximately 660° C. (degree Celsius). Therefore, a matrix 115 having a transformation point (such as glass transition point and melting point) in a temperature range lower than 660° C. is selected.

The matrix 115 can be formed by use of one or more types of plastic materials selected from a group consisting of polyethylene, polypropylene, fluorine-based resin, polyimide resin, polyetheretherketone, epoxy resin, polystyrene and polyethylene terephthalate, for example.

Each of the above plastic materials has a transformation point (such as glass transition point and melting point) lower than 660° C. For example, the melting point of polyethylene is approximately 107° C. to 140° C., that of polypropylene is approximately 150° C. to 170° C., that of polyetheretherketone is approximately 335° C., that of polystyrene is approximately 80° C. to 100° C., and that of polyethylene terephthalate is approximately 265° C.

As the fluorine-based resin, resins such as PTFE (melting point: approximately 327° C.), FEP (melting point: approximately 253° C. to 282° C.), ETF (melting point: approximately 260° C. to 270° C.), ETF (melting point: approximately 260° C. to 270° C.) and polyvinylidene fluoride (PVDF) (melting point: approximately 160° C. to 185° C.) can be employed, for example.

As the polyimide resin, resins such as polyimide (melting point: approximately 410° C.), polyamideimide (melting point: approximately 260° C.), polyetherimide (melting point: approximately 217° C.) and polyaminobismaleimide (melting point: approximately 290° C.) can be employed, for example.

Crystalline epoxy resin (melting point: approximately 115° C. to 145° C.) may also be used as the matrix 115. Further, a copolymer or a mixture of two or more of the above-described plastic materials (resins) may also be selected as the matrix.

As above, the matrix 115 is formed of plastic having a transformation point in a temperature range lower than the melting point of the positive electrode current collector member 180. Therefore, after the temperature of the matrix 115 rises along with the temperature rise of the positive electrode current collector member 180, the plastic material forming the matrix 115 reaches its melting point and transforms. At this time, the temperature rise of the positive electrode current collector member 180 is restricted by the endothermic effect of the latent heat of melting. Also in cases where a material having the glass transition point is selected as the matrix 115, when the plastic material forming the matrix 115 reaches the glass transition point and transforms, the temperature rise of the positive electrode current collector member 180 would be similarly restricted due to the endothermic effect of the latent heat of transition.

The amount of heat absorbed as a result of the transformation is considerably high. In the case of polyethylene, for example, the heat of fusion is 220 kJ/kg. Since the specific heat of polyethylene is 2.3 kJ/(kg·K), adding 220 J of heat to 1 g of polyethylene causes a temperature rise of the polyethylene by approximately 96° C. In contrast, when the temperature of the 1 g of polyethylene has already risen to the vicinity of the melting point, no temperature rise over the melting point occurs until 220 J of heat is absorbed by the polyethylene. Thus, the temperature rise of the current collector member can be restricted efficiently by use of the latent heat of transformation. In a case where a plastic material that undergoes crystal structure transformation is employed, a certain amount of heat would be absorbed by the plastic material and the temperature rise of the current collector member would be restricted when the temperature of the matrix 115 has risen to the vicinity of the glass transition point.

A material with greater latent heat is more suitable for use for the matrix 115 since such a material is capable of absorbing a greater amount of heat. Further, a material with a higher melting point is more suitable for use for the matrix 115 since such a material is capable of maintaining the solid shape up to a high temperature range and of stably absorbing heat.

The heat from the positive electrode current collector member 180 is transmitted to the vicinity of the contact surface 110a via the contact surface 110a of the temperature control member 110. The heat transmitted to the vicinity of the contact surface 110a of the temperature control member 110 is transmitted in the thickness direction in the temperature control member 110. Consequently, a temperature rise is caused to the entire matrix 115. However, the aforementioned plastic forming the matrix 115 is plastic having low thermal conductivity. For example, the thermal conductivity of low density polyethylene is approximately 0.38 W/(m·K), and that of high density polyethylene is approximately 0.46 to 0.50 W/(m·K). Thus, in a case where the temperature control member 110 is formed of plastic alone, the heat would not be transmitted to the whole of the temperature control member 110 and the endothermic effect making use of the latent heat of transformation of the plastic could not be achieved effectively.

In the present embodiment which has been designed in consideration of the above problem, the thermal conductivity of the temperature control member 110 is enhanced by mixing a certain amount of filler 116, having higher thermal conductivity than the plastic forming the matrix 115 and having the electric insulation property, into the temperature control member 110. Thanks to the enhancement of the thermal conductivity of the temperature control member 110, the heat from the positive electrode current collector member 180 can be efficiently transmitted to the whole of the temperature control member 110, by which the endothermic effect employing the latent heat of transformation of the plastic can be achieved efficiently.

The matrix 115 can contain ceramic having high thermal conductivity and a high electric insulation property. For example, the matrix 115 can contain one or more types of fillers 116 selected from a group consisting of silicon carbide [thermal conductivity: approximately 270 W/(m·K)], boron nitride [thermal conductivity: approximately 110 W/(m·K)], silicon nitride [thermal conductivity: approximately 30 to 80 W/(m·K)] and magnesia [thermal conductivity: approximately 40 W/(m·K)].

In a case where the filler 116 is mixed into the matrix 115 in order to enhance the thermal conductivity of the temperature control member 110, the thermal conductivity would increase corresponding to the increase in the volume fraction of the filler 116. It is desirable to set the volume fraction of the filler 116 at a value greater than or equal to the percolation threshold. The percolation threshold is the volume fraction when the phenomenon called percolation occurs. The percolation is a phenomenon in which a conductive filler aggregates when its volume fraction reaches the percolation threshold, thereby forming a cluster extending throughout the system and exhibiting conductivity. The percolation threshold, which is determined by the type of the plastic forming the matrix, the type and particle shape of the filler 116, or the method of mixing, is approximately 5% to 30%. Therefore, the filler 116 is preferably dispersed in the matrix 115 at a volume fraction of approximately 30% or higher.

While increasing the content of the fillet 116 can enhance the thermal conductivity more, a too high volume fraction of the filler 116 leads to an unduly low volume fraction of the matrix 115. Thus, it will be necessary to increase the volume of the matrix 115 (i.e., increase the volume of the temperature control member 110) in order to sufficiently achieve the endothermic effect employing the latent heat of transformation. The temperature control member 110 has to be arranged in a limited space in the battery container. Thus, the content of the filler 116 is determined with the size of the temperature control member 110 stored in the battery container taken into consideration as well. In consideration of the achievement of a sufficient endothermic effect employing the latent heat of transformation and the storage of the temperature control member 110 in the battery container, it is desirable to set the volume fraction of the filler 116 at a value less than 50%, that is, to set the volume fraction of the matrix 115 at value higher than or equal to 50%.

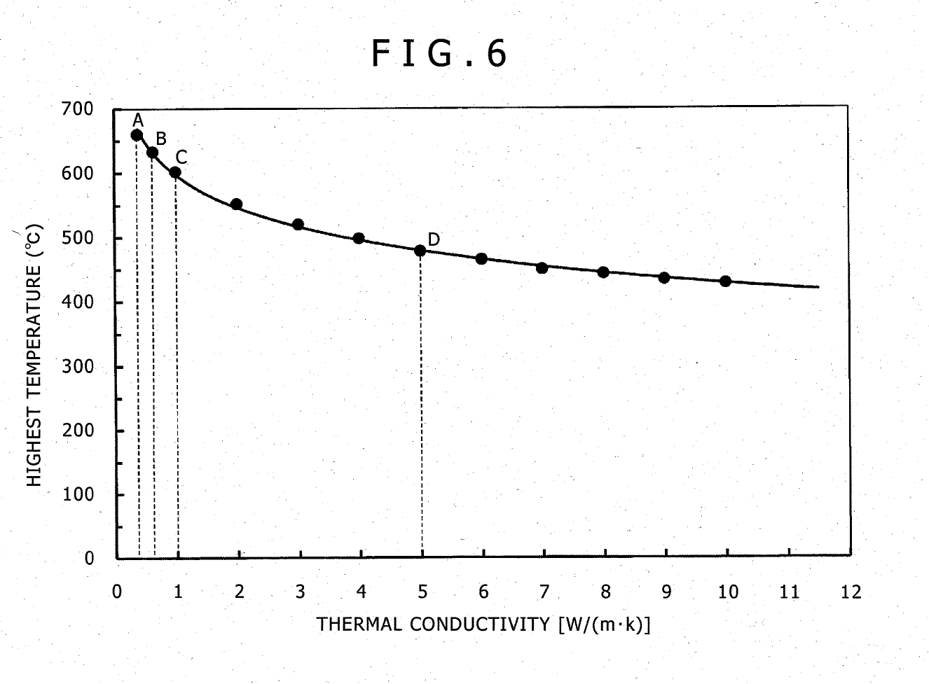

FIG. 6 is a graph showing the relation between the thermal conductivity of the temperature control member 110 and the maximum temperature of the positive electrode current collector member 180. FIG. 6 shows results of numerical simulation in cases where polyethylene (heat of fusion: 220 kJ/kg) is employed as the matrix 115 of the temperature control member 110 and certain electric current is fed through the positive electrode current collector member 180. The point A is a result of numerical simulation showing the maximum temperature in a case where the positive electrode current collector member 180 is provided with a member having thermal conductivity of 0.38 W/(m·K) with assumption of a plastic material containing no filler 116. As indicated by the point A, when the temperature control member 110 contains no filler 116, the maximum temperature reaches as high as 660° C., which is the melting point of the positive electrode current collector member 180. This can be attributed to insufficient achievement of the endothermic effect by the latent heat of transformation due to inefficient transmission of heat to the entire temperature control member 110.

Each of the results other than the point A indicates the maximum temperature in a case where a temperature control member 110 containing the filler 116 and thereby having enhanced thermal conductivity is used. As indicated by the point B, when the positive electrode current collector member 180 is provided with a temperature control member 110 having thermal conductivity of 0.63 W/(m·K), the maximum temperature drops to 633° C., exhibiting the temperature rise restriction effect.

With the increase in the thermal conductivity, the temperature rise of the positive electrode current collector member 180 was restricted more effectively by the endothermic effect of the temperature control member 110. When a temperature control member 110 having thermal conductivity of 1 W/(m·K) was used, the maximum temperature was 602° C. (point C). When a temperature control member 110 having thermal conductivity of 5 W/(m·K) was used, the maximum temperature was 478° C. (point D), achieving a great temperature rise restriction effect. Therefore, it is preferable to employ a temperature control member 110 having thermal conductivity of 1 W/(m·K) or higher, and more preferable to employ a temperature control member 110 having thermal conductivity of 5 W/(m·K) or higher.

It should be noted that the negative electrode current collector member 190 is also similarly provided with the temperature control member 110. The melting point of the copper-based metal forming the negative electrode current collector member 190 is approximately 1,085° C. In other words, the melting point of the negative electrode current collector member 190 is higher than that of the positive electrode current collector member 180. Therefore, the matrix 115 is configured with a plastic material having a transformation point in a temperature range lower than the melting point of the positive electrode current collector member 180. As a result, the temperature rise of the negative electrode current collector member 190 can be restricted effectively even in cases where the negative electrode current collector member 190 is provided with the same temperature control member 110.

According to the present embodiment which has been described above, the following operational advantages can be achieved.

(1) In the secondary battery 100, the flat plate parts 182 and 192 between the joint plates 183 and 193 and the terminal connection parts 181 and 191 of the positive-negative electrode current collector members 180 and 190 is provided with the temperature control member 110. The temperature control member 110 is formed of a composite material made by the filler 116 being dispersed in the matrix 115. The matrix 115 has a transformation point (such as glass transition point and melting point) in a temperature range lower than the melting point of the current collector member provided with the temperature control member 110. The filler 116 has higher thermal conductivity than the matrix 115.

With this configuration, when excessive current flows through the secondary battery 100 and the rising temperature of a current collector member reaches the transformation point of the matrix 115, the temperature rise of the current collector member will be restricted by the endothermic effect due to the latent heat of transformation. Consequently, the occurrence of abnormal phenomena such as an internal short circuit, caused by partial fusion of the current collector member, and a voltage drop can be prevented.

In the secondary battery of the Patent Document 1 in which each current collector member is equipped with a fuse, high electric power can retain in the secondary battery and the high energy state of the secondary battery might be maintained after the disconnection of the fuse. In contrast, according to the present embodiment, in case of excessive current flowing through the secondary battery, the temperature rise of the positive-negative electrode current collector members 180 and 190 can be restricted without the electrical connection between the positive-negative external terminals 141 and 151 and the winding electrode 170 interrupted.

According to the present embodiment, the electrical connection between the positive-negative external terminals 141 and 151 and the winding electrode 170 is not interrupted. Therefore, at the time of maintenance, it is possible to reduce the electric power in the secondary battery 100 and shift the secondary battery 100 to a low energy state by easily discharging the secondary battery 100 from the outside of the battery.

(2) The matrix 115 and the filler 116 both have the electric insulation property. Therefore, occurrence of the self-short-circuit phenomenon would be prevented even in a case where the insulating case 108 is melted due to a great temperature rise of the temperature control member 110. Moreover, short circuits between the temperature control members 110 and the electrodes of the winding electrode 170 would also be prevented.

(3) The temperature control member 110 is formed in a clip-like shape to have a pair of engaging pieces 110b capable of elastically deforming. Between the pair of engaging pieces 110b, the contact surface 110a to be in contact with the flat plate parts 182 and 192 is formed. The temperature control member 110 can be fixed on the flat plate parts 182 and 192 with the contact surface 110a in contact with the flat plate parts 182 and 192 by means of the elastic resilience of the pair of engaging pieces 110b. Thus, the temperature control members 110 can be attached to the current collector members with ease at the manufacturing process of the secondary battery 100.

### Second Embodiment

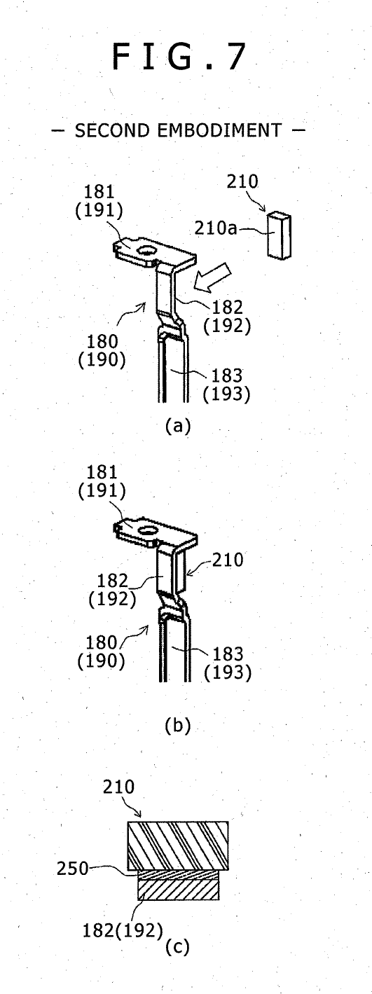

A secondary battery according to a second embodiment of the present invention will be described below with reference to FIG. 7. FIG. 7 is a schematic diagram showing a temperature control member 210 which is attached to each current collector member in the secondary battery according to the second embodiment of the present invention with the use of an adhesive agent. Components in FIG. 7 that are identical or equivalent to those in the first embodiment are assigned the same reference characters as in the first embodiment and the following explanation will be given mainly of the difference from the first embodiment. While only the temperature control member 210 connected to the positive electrode current collector member 180 is shown in FIG. 7, the negative electrode current collector member 190 is also provided with the same temperature control member 210. Thus, reference numerals of the components of the negative electrode current collector member 190 are shown in FIG. 7 in the parenthesized form for the convenience of illustration. Since the same temperature control members 210 are connected to the positive electrode current collector member 180 and the negative electrode current collector member 190, the temperature control member 210 connected to the positive electrode current collector member 180 will be explained below as the representative example.

In the first embodiment described above, the clip-shaped temperature control member 110 is attached to each current collector member by using elastic force (see FIG. 4). In contrast, the temperature control member 210 in the second embodiment is bonded to the flat plate part 182 of the positive electrode current collector member 180 with the use of an adhesive agent as shown in FIG. 7. For example, a heat-resistant epoxy adhesive having the thermosetting property can be used as the adhesive agent.

As shown in FIG. 7(a), the temperature control member 210 in a rectangular prism shape has a contact surface 210a to be in contact with the flat plate part 182 of the positive electrode current collector member 180. The temperature control member 210 is bonded to the flat plate part 182 by applying the adhesive agent to the contact surface 210a of the temperature control member 210 and to the contact surface of the flat plate part 182 and holding the temperature control member 210 and the flat plate part 182 in contact with each other while applying pressure to them from outside. After the adhesive agent has hardened, the temperature control member 210, in contact with the flat plate part 182 via a layer 250 of the adhesive agent, is fixed on the flat plate part 182 as shown in FIGS. 7(b) and 7(c).

The temperature control member 210 can be fixed also on the negative electrode current collector member 190 with the use of the adhesive agent in a similar manner.

As described above, in the second embodiment, the adhesive agent layer 250 connecting the temperature control member 210 and the flat plate part 182 together is formed between the temperature control member 210 and the flat plate part 182. Therefore, advantages similar to those in (1) and (2) described in the first embodiment can be achieved according to the second embodiment. Further, according to the second embodiment, the temperature control member 210 can be fixed on the positive-negative electrode current collector members 180 and 190 more firmly compared to the first embodiment since the temperature control member 210 is bonded to the positive-negative electrode current collector members 180 and 190 with the use of an adhesive agent.

### Third Embodiment

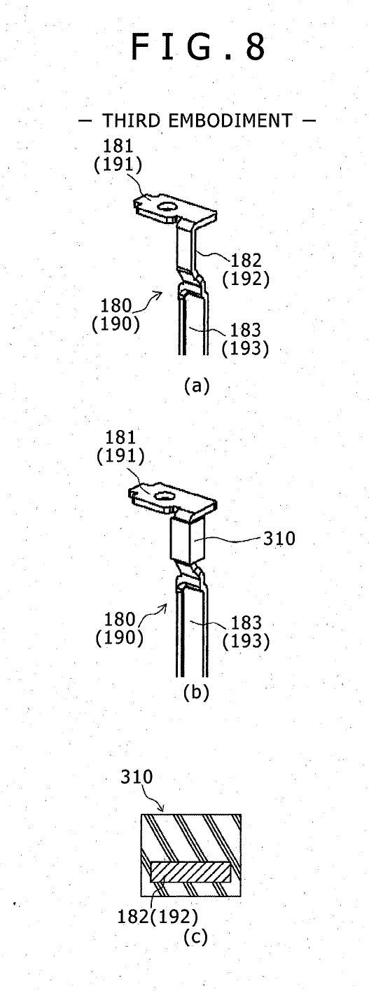

A secondary battery according to a third embodiment of the present invention will be described below with reference to FIG. 8. FIG. 8. is a schematic diagram showing a temperature control member 310 which is formed integrally with each current collector member in the secondary battery according to the third embodiment of the present invention by means of outsert molding. Components in FIG. 8 that are identical or equivalent to those in the first embodiment are assigned the same reference characters as in the first embodiment and the following explanation will be given mainly of the difference from the first embodiment. While only the temperature control member 310 connected to the positive electrode current collector member 180 is shown in FIG. 8, the negative electrode current collector member 190 is also provided with the same temperature control member 310. Thus, reference numerals of the components of the negative electrode current collector member 190 are shown in FIG. 8 in the parenthesized form for the convenience of illustration. Since the same temperature control members 310 are connected to the positive electrode current collector member 180 and the negative electrode current collector member 190, the temperature control member 310 connected to the positive electrode current collector member 180 will be explained below as the representative example.

In the third embodiment, the temperature control member 310 is formed integrally with the flat plate part 182 of the positive electrode current collector member 180 by means of outsert molding. FIG. 8(a) shows a state before the integral formation of the temperature control member 310. Prior to the outsert molding, fine irregularities (projections and depressions) are formed on the surface of the flat plate part 182 of the positive electrode current collector member 180 through alumite treatment, abrasive blasting or the like. Thereafter, a mold (not shown) is set up to surround the flat plate part 182 of the positive electrode current collector member 180, the material for forming the temperature control member 310 is melted and injected into the mold, and the material is solidified thereby.

At the stage when the mold is removed, the temperature control member 310 has been formed integrally with the flat plate part 182 to cover the positive electrode current collector member 180 and has been fixed on the positive electrode current collector member 180 as shown in FIGS. 8(b) and 8(c). Since the fine irregularities have been formed on the surface of the flat plate part 182 of the positive electrode current collector member 180, the temperature control member 310 adheres to the irregularities and is firmly fixed to the flat plate part 182.

The temperature control member 310 can also be formed integrally with the negative electrode current collector member 190 in a similar manner.

As described above, in the third embodiment, the temperature control member 310 is formed integrally with the flat plate parts 182 and 192 so as to cover them. Therefore, advantages similar to those in (1) and (2) described in the first embodiment can be achieved according to the third embodiment. Further, according to the third embodiment, the temperature control member 310 can be fixed on the positive-negative electrode current collector members 180 and 190 more firmly compared to the first and second embodiments since the temperature control member 310 is formed integrally with the positive-negative electrode current collector members 180 and 190.

Modifications described below are also within the scope of the present invention. It is also possible to combine one or more of the modifications with any one of the above embodiments.

### MODIFICATIONS

(1) The clip-shaped temperature control member 110 in the first embodiment may also be connected to the positive-negative electrode current collector members 180 and 190 with the use of the adhesive agent described in the second embodiment.

(2) While the material and the shape of the temperature control member connected to the positive electrode current collector member 180 and those of the temperature control member connected to the negative electrode current collector member 190 are identical with each other in the first through third embodiments, the present invention is not limited to such examples. It will be sufficient as long as the matrix forming the temperature control member provided for the positive electrode current collector member 180 has a transformation point in a temperature range lower than the melting point of the positive electrode current collector member 180 and the matrix forming the temperature control member provided for the negative electrode current collector member 190 has a transformation point in a temperature range lower than the melting point of the negative electrode current collector member 190. Therefore, the temperature control member for the positive electrode current collector member 180 and the temperature control member for the negative electrode current collector member 190 may be formed of different materials. It is also possible to form the temperature control member for the positive electrode current collector member 180 and the temperature control member for the negative electrode current collector member 190 in different shapes.

(3) While each of the positive electrode current collector member 180 and the negative electrode current collector member 190 is provided with the temperature control member in the first through third embodiments, the present invention is not limited to such examples. The melting point of the aluminum-based metal forming the positive electrode current collector member 180 is approximately 660° C., whereas the melting point of the copper-based metal forming the negative electrode current collector member 190 is approximately 1,085° C. Therefore, it is possible to provide the temperature control member at least for the positive electrode current collector member 180 made of aluminum-based metal and properly leave out the temperature control member from the negative electrode current collector member 190 made of copper-based metal.

(4) The matrix 115 is not limited to those made of the aforementioned plastic materials. A variety of electrically insulating plastic materials having a transformation point in a temperature range lower than the melting point of the current collector member provided with the temperature control member can be employed as the matrix 115.

(5) The filler 116 is not limited to those made of the aforementioned ceramic materials. A variety of electrically insulating materials having higher thermal conductivity than the matrix 115 can be employed as the filler 116.

(6) The connecting structure between the temperature control member and the current collector member is not limited to those described in the above embodiments. For example, a fixation member made of electrically insulating material having a high heat-resisting property may be provided separately from the current collector member and the temperature control member. The fixation member may be formed in a clip-like shape with a pair of holding parts to be capable of elastic deformation, for example. The pair of holding parts sandwiching the temperature control member and the current collector member together from both sides fixes the temperature control member on the current collector member.

(7) While the battery container is formed in a prismatic shape in the above embodiments, the present invention is not limited to such examples. Various types of battery containers in flat or thin shapes (e.g., flat battery container having an elliptical cross-sectional shape) may be employed.

(8) While the above explanation has been given with a lithium-ion secondary battery taken as an example of the secondary battery, the present invention is applicable also to other types of secondary batteries such as nickel-hydrogen batteries.

(9) The structure of the positive-negative electrode current collector members 180 and 190 and the winding electrode 170 is not limited to those described in the above embodiments. It is possible to form the electrode connection part of the current collector member in a forked shape, separate the laminated part of the non-coated parts 176b and 177b of the positive-negative electrodes 174 and 175 of the winding electrode 170 into two bundles to form bundle-like electrode parts, and join the forked electrode connection part to the bundle-like electrode parts. The structure of each external terminal and the connecting structure between each external terminal and the corresponding current collector member are also not limited to those in the above embodiments.

While various embodiments and modifications have been described above, the present invention is not limited to the contents of the embodiments and modifications; other modes of implementation conceivable within the scope of the technical ideas of the present invention are also contained in the scope of the present invention.

1. A secondary battery comprising:
a power generation element having an electrode;
a battery container which stores the power generation element;
an external terminal arranged on the battery container;
a current collector member including an electrode connection part connected to the electrode of the power generation element, a terminal connection part connected to the external terminal, and a thermal connection part formed between the electrode connection part and the terminal connection part; and
a temperature control member provided for the terminal connection part to restrict a temperature rise of the current collector member, wherein:
the temperature control member is formed of a composite material made by dispersing a filler having an electric insulation property in a matrix made of plastic having the electric insulation property;
the matrix has a transformation point in a temperature range lower than a melting point of the current collector member provided with the temperature control member;
the filler has higher thermal conductivity than the matrix; and
the volume fraction of the filler contained in the matrix is higher than or equal to a percolation threshold.

2. The secondary battery according to claim 1, wherein:
the temperature control member is provided for at least a current collector member that is made of aluminum-based metal; and
the melting point of the matrix is lower than the melting point of the aluminum-based metal forming the current collector member.

3. The secondary battery according to claim 2, wherein the matrix is made of one or more types of plastic materials selected from a group consisting of polyethylene, polypropylene, fluorine-based resin, polyimide resin, polyetheretherketone, epoxy resin, polystyrene and polyethylene terephthalate.

4. The secondary battery according to claim 3, wherein the matrix contains one or more types of fillers selected from a group consisting of silicon carbide, boron nitride, silicon nitride and magnesia.

5. The secondary battery according to claim 4, wherein:
the battery container includes a battery case in a bottomed box shape for storing the power generation element and a battery cover for sealing up an opening of the battery case;
the battery cover is provided with the external terminal;
the terminal connection part is arranged along an inner surface of the battery cover;
the thermal connection part bends from a lateral part of the terminal connection part and extends toward a base surface of the battery case; and
the electrode connection part is connected to the thermal connection part and joined to the electrode of the power generation element.

6. (canceled)

7. The secondary battery according to claim 5, wherein the thermal conductivity of the temperature control member is higher than or equal to 5 W/(m·K).

8. The secondary battery according to claim 7, wherein:
the temperature control member includes a pair of engaging pieces capable of elastically deforming and a contact part formed between the pair of engaging pieces; and
the temperature control member is fixed on the thermal connection part with the contact part in contact with the thermal connection part by elastic resilience of the pair of engaging pieces.

9. The secondary battery according to claim 8, wherein an adhesive layer for connecting the temperature control member and the thermal connection part together is formed between the temperature control member and the thermal connection part.

10. The secondary battery according to claim 7, wherein the temperature control member is formed integrally with the thermal connection part so as to cover the thermal connection part.
